(19) United States
(12) Patent Application Publication
(10) Pub. No.: US 2026/0035918 A1
(43) Pub. Date: Feb. 5, 2026

(54) PRE-STRESSED PULTRUDED FIBER REINFORCED THERMOPLASTIC LUMBER

(71) Applicant: Mark A. Porter, Jacksonville, FL (US)

(72) Inventor: Mark A. Porter, Jacksonville, FL (US)

(21) Appl. No.: 19/352,381

(22) Filed: Oct. 7, 2025

Related U.S. Application Data
(63) Continuation-in-part of application No. 18/497,968, filed on Oct. 30, 2023.

(51) Int. Cl. E04C 3/29; B29C 70/00; B29C 70/08; B29C 70/52; B29C 70/56; B29K 27/06; B29K 307/04; B29K 309/08; B29L 31/00

(52) U.S. Cl. CPC E04C 3/29; B29C 70/003; B29C 70/081; B29C 70/52; B29C 70/56; B29K 2027/06; B29K 2307/04; B29K 2309/08; B29L 2031/001

(57) ABSTRACT

An integrally formed, pre-stressed thermoplastic lumber product and a method for its manufacture are disclosed. The product comprises a core of a thermoplastic polymer, such as PVC, blended with chopped strand fibers. A plurality of pre-tensioned continuous fiber reinforcements are pultruded axially within the core. Enhanced frictional and mechanical coupling between the chopped fibers and the continuous reinforcements resists delamination and enables the effective transfer of tensile stress into compressive pre-stress within the core. The resulting lumber, finished with a co-extruded capstock layer, is a high-stiffness composite exhibiting a modulus of elasticity of at least 650,000 psi. The method involves the simultaneous co-extrusion of the core and capstock around the tensioned, pultruded continuous reinforcements.

### CROSS-REFERENCE TO RELATED APPLICATIONS

This application is a continuation in part of U.S. Nonprovisional application Ser. No. 18/497,968 filed Oct. 30, 2023, the entire contents of which are incorporated herein and made a part hereof by this reference.

### FIELD OF THE INVENTION

This invention relates generally to structural materials used in construction and, more particularly, to a cost-effective, extruded thermoplastic lumber with internal reinforcement and pre-stressing. The invention is designed to overcome the inherent limitations of traditional wood lumber, especially in harsh environments such as marine and outdoor construction.

### BACKGROUND OF THE INVENTION

Traditional wood lumber, commonly utilized in various construction applications, faces significant inherent limitations that necessitate frequent replacement and maintenance. These shortcomings include susceptibility to wood-decaying fungi, termites, wood-boring beetles, and moisture, which collectively lead to fungal growth, rot, and warping. Furthermore, wood degrades when exposed to ultraviolet (UV) radiation and can be weakened by chemicals such as acids, alkalis, or corrosive substances.

Historically, chemical pesticides, or wood preservatives like creosote, pentachlorophenol, and inorganic arsenicals such as chromated copper arsenate (CCA), were extensively applied to wood to mitigate decay and organism attack. However, scientific, environmental, and regulatory concerns arose regarding the health risks posed by preserved wood and the leaching of toxic preservatives, particularly in marine construction where they could contaminate water and harm marine life. Consequently, the use of such preservatives is now generally restricted or prohibited in marine environments. This creates a clear need for a durable, structurally sound, and environmentally benign lumber alternative.

A known technique to enhance structural performance in materials like concrete is prestressing, which involves inducing compressive stresses within the material before it experiences external loads. In this process, a predetermined tensile stress is applied to reinforcing elements, typically steel cables, and then the concrete is cast around them. Upon curing and release of the tensile force, compressive stresses are transferred to the concrete, significantly improving its strength, stiffness, and resistance to cracking.

However, applying prestressing techniques to extruded thermoplastics presented a significant challenge in the prior art. For instance, U.S. Pat. No. 5,096,645 disclosed a method of pultruding a stressed reinforcing element in an extruded thermoplastic, but a critical problem was delamination or debonding (i.e., decoupling) of the reinforcing element from the plastic after the stress-inducing force was removed and the thermoplastic cured. As the relaxed reinforcing element contracts, the physical bonds between the reinforcement and the thermoplastic are compromised, leading to decoupling and the elimination of the beneficial prestressing effect. This directly limited the ability to produce a reliable, pre-stressed extruded thermoplastic structure.

There is a pronounced need for a cost-effective, pre-stressed extruded structure that could overcome this decoupling issue and exhibit enhanced mechanical properties for demanding applications, such as stringers in dock construction. The strength of stringers directly impacts the allowable distance between costly and difficult-to-set pilings; stronger stringers permit wider spacing, leading to significant financial and construction benefits. Beam bending theory dictates that the deflection of a stringer is inversely proportional to its modulus of elasticity. Therefore, to reduce deflection and allow greater spanning lengths, a higher modulus of elasticity is required. The prior art lacked such a pre-stressed extruded structure that could exhibit a modulus of elasticity sufficiently high to compete with or exceed conventional wood lumber, thereby allowing increased spacing between pilings.

Thus, there is a clear and compelling need for a pre-stressed, extruded structural member that addresses the limitations of wood and overcomes the bonding challenges encountered in thermoplastic reinforcement. Such a material should maintain an effective and durable bond between the reinforcement and plastic matrix after curing and stress release; exhibit a higher modulus of elasticity than comparably sized wood members, enabling greater spans and reduced piling count; be inert to marine organisms and resistant to biological degradation; contain no toxic chemicals that could leach into aquatic environments; be workable with conventional tools—cut, drilled, or fastened as easily as wood; and withstand long-term exposure to sun, rain, temperature fluctuations, and UV radiation without degrading.

The present invention addresses these needs and overcomes one or more of the technical limitations identified above by providing a novel, pre-stressed, internally reinforced thermoplastic structural member optimized for demanding construction environments.

### SUMMARY OF THE INVENTION

The invention provides an integrally formed, pre-stressed, fiber-reinforced thermoplastic structural member that exhibits a modulus of elasticity exceeding 650,000 psi, enabling longer spans and reduced support count; prevents reinforcement/matrix decoupling via a synergistic microstructure that mechanically interlocks continuous reinforcements with a heterogeneous chopped-fiber network; resists biological and environmental degradation without toxic preservatives; and is readily cut, drilled, and fastened with conventional tools.

The member includes a composite core formed from a thermoplastic polymer—preferably polyvinyl chloride (PVC)—blended with chopped strand fibers (e.g., glass fibers) totaling 15-40 wt % of the core. The chopped fibers (e.g., E-glass, initial average length about 0.125-0.50 in) are processed to retain at least 60% of their initial average length after extrusion, ensuring a robust, roughened internal architecture. Continuous fiber reinforcements (e.g., fiberglass or carbon fiber rovings) are pultruded axially and pre-tensioned during extrusion, then relaxed post-cooling to impart compressive pre-stress into the core. A co-extruded capstock provides UV/IR protection, weatherability, and aesthetics.

The chopped-fiber network—present as intact pellets, clumps, and separated strands—forms a mechanically interlocking “brush” that enhances frictional coupling and shear transfer into the continuous reinforcements, preventing delamination after tension release and throughout service. This synergy allows the core to accept and retain compressive pre-stress, maintaining high stiffness and flexural strength.

Representative products demonstrate a modulus of elasticity ≥650,000 psi (and, in optimized embodiments, higher), with superior flexural strength versus comparably sized pine lumber. The thermoplastic matrix and capstock confer UV, IR, saltwater, and chemical resistance, while optional foaming can reduce density for improved workability without sacrificing structural performance due to the dual-reinforcement system.

A method of manufacturing an integrally formed pre-stressed fiber-reinforced member comprises: blending a thermoplastic polymer and chopped strand fibers to form a core mixture, the chopped strand fibers selected and processed to retain ≥60% of initial average length after extrusion; introducing a plurality of continuous fiber reinforcements into an extruder; applying tensile stress to the continuous reinforcements; co-extruding the core mixture and a capstock composition around the tensioned reinforcements such that the reinforcements are pultruded axially within and coextensive with the core; cooling the extrudate to below the polymer glass transition temperature (for PVC, approximately 175-185° F. (80-85° C.)) to solidify; and severing the continuous reinforcements, thereby transferring compressive stress to the core to create a pre-stressed structure.

An exemplary member comprises: a core of PVC blended with 15-40 wt % chopped E-glass fibers having an initial average length of 0.125-0.50 in and >60% length retention post-extrusion; a plurality of continuous fiberglass or carbon fiber rovings embedded axially and pre-tensioned during extrusion; and a co-extruded capstock devoid of fibers and optionally containing IR-reflective pigments (e.g., TiO₂, ZnO) and UV inhibitors. The overall product modulus exceeds 650,000 psi and exhibits enhanced flexural performance.

### BRIEF DESCRIPTION OF THE DRAWINGS

The foregoing and other aspects, objects, features, and advantages of the invention will become better understood with reference to the following description, appended claims, and accompanying drawings, where:

FIG. 1 is a profile view of an exemplary extruded thermoplastic pre-stressed lumber according to principles of the invention.

FIG. 2 is a perspective view of an exemplary extruded thermoplastic lumber according to principles of the invention.

FIG. 3 is a high-level flowchart of steps of an exemplary method of producing an extruded pre-stressed thermoplastic lumber according to principles of the invention.

FIG. 4 provides a schematic that conceptually illustrates an extrusion and pultrusion line for producing an exemplary pre-stressed extruded thermoplastic lumber according to principles of the invention.

Those skilled in the art will appreciate that the figures are schematic in nature and are not intended to be drawn to any particular scale; nor are the figures intended to illustrate every possible embodiment of the invention. The invention is not limited to the exemplary embodiments depicted in the figures or the specific components, configurations, shapes, relative sizes, ornamental aspects, or proportions as shown.

### DETAILED DESCRIPTION OF THE INVENTION

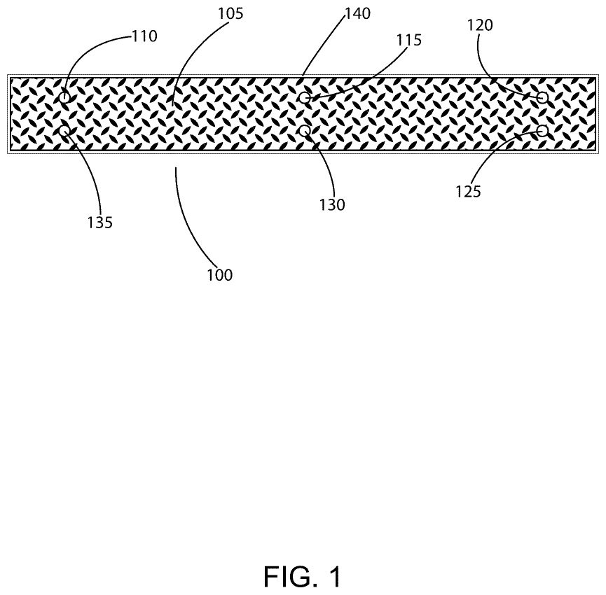

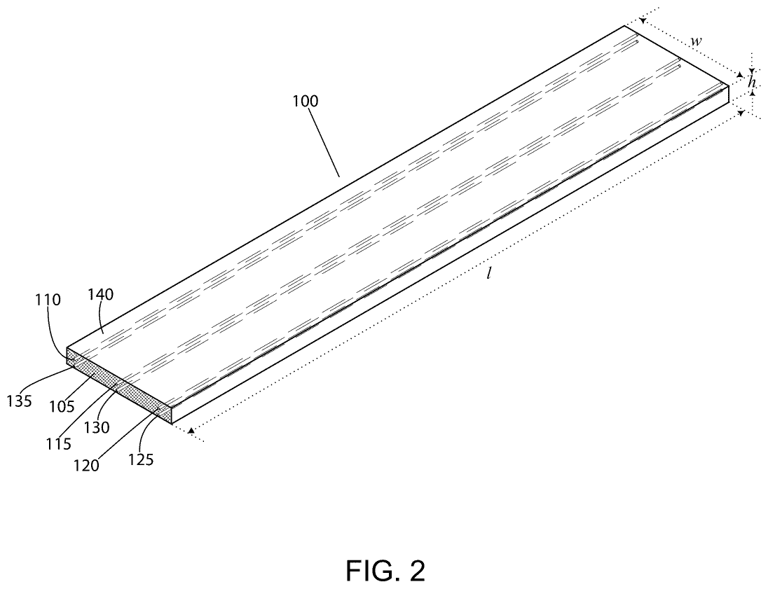

With reference to FIGS. 1 and 2, an exemplary integrally formed extruded thermoplastic lumber 100 according to the principles of the invention includes an inner core 105, a plurality of elongated continuous fiber reinforcements 110-135, and a co-extruded capstock layer 140. The core 105 is comprised of a thermoplastic material, such as polyvinyl chloride (PVC), blended with chopped strand glass fibers. A critical aspect of the invention is the condition of these chopped fibers within the cured core 105. They are present in a heterogeneous distribution of forms, specifically as intact or partially intact pellets of pelletized glass fibers, clumps of glass fiber strands, and individual strands of glass fibers. This distribution arises during manufacturing, where shear forces break down some pellets while leaving others whole or in clumps, all of which become encapsulated within the thermoplastic matrix.

As used herein, the term “lumber” is to be interpreted broadly to refer to any elongated extruded structural product suitable for building and load-bearing applications. The term is used to denote the product's form and function as a structural member, analogous to traditional wood lumber, but is not intended to imply that the product is made from wood or wood-based materials. Furthermore, the term “lumber” is not limited to exclusively solid structures but encompasses hollow-core products, tubular products having walls extending between sides of the interior surfaces, products having a solid, cellular, or foamed internal core, sheet-like products that are planar or corrugated, and other configurations suitable for structural uses. Furthermore, the term “lumber” is not limited to any particular cross-sectional shape or profile, but encompasses all shapes and profiles.

The thermoplastic material of the core 105, preferably PVC, is advantageous due to its relative inexpensiveness, resistance to environmental degradation, high hardness, and outstanding tensile strength for a plastic. While PVC is preferred, other extrudable thermoplastics like acrylonitrile butadiene styrene (ABS), polyoxymethylene (POM), and polyolefins (e.g., high-density polyethylene, polypropylene) may be used. To improve the processability of PVC, which exhibits very high viscosity, various additives may be introduced. A plasticizer, such as dioctyl terephthalate (DOTP), can decrease melt viscosity and improve the flexibility and durability of the final product. A lubricant, such as calcium acetylacetonate (ORC-A), may be incorporated to reduce friction between the processing machinery and the plastic, as well as internally between polymer molecules and reinforcing fibers. A heat stabilizer (e.g., barium-zinc, calcium-zinc, or aluminum magnesium carbonate hydroxide) is essential to prevent thermal degradation and the release of hydrochloric acid (HCl) at extrusion temperatures. Furthermore, an impact modifier, such as precipitated calcium carbonate (PCC), may be added to enhance the overall durability, toughness, weatherability, and tensile properties of the extruded lumber 100.

The chopped strand glass fibers within the core 105 serve as a primary reinforcement. These fibers may be composed of carbon and/or oxides of silicon, calcium, aluminum, magnesium, and/or boron, with a common type being E-glass, an alumino-borosilicate glass. They are produced as small diameter strands (e.g., approximately 5 to 18 m) with a relatively short initial average length (e.g., about 0.125 to 0.50 inches). In a preferred embodiment, these fibers are utilized in a pelletized form, where each pellet is an agglomeration of numerous individual strands held by a binder. The glass fibers constitute a substantial portion of the core material, typically comprising between 15-40% by weight, and in a particular embodiment, between 20% and 35% by weight of the extruded material, excluding the capstock 140.

A plurality of elongated continuous fiber reinforcements 110-135, such as rovings, e.g., fiberglass or carbon fiber rovings, extend longitudinally through the extruded lumber 100, coextensive with the core 105. These reinforcements 110-135 are pre-tensioned and pultruded axially within the core 105 during the extrusion process. After the extruded structure is cured and cut to length, this pre-tensioning allows tensile stress to be transferred from the embedded fibers 110-135 to the core 105 as compressive stress, resulting in a pre-stressed composite structure. The ability of the core 105 to handle this compressive stress without buckling is critical.

A key synergistic interaction occurs between the chopped strand glass fibers and the continuous fiber reinforcements 110-135 within the core 105. The manufacturing process is controlled such that at least 60% of the initial average length of the chopped fibers is retained post-extrusion. This significant length retention ensures the fibers create a rough internal structure. This structure, formed by the heterogeneous distribution of pellets, clumps, and individual strands, provides enhanced frictional coupling and mechanical entanglement with the continuous reinforcements 110-135. These numerous points of physical contact act as microscopic mechanical locks, forming robust couplings that impede any tendency for the continuous fibers 110-135 to debond or delaminate from the thermoplastic matrix. This enhanced friction and mechanical interlocking are crucial for maintaining the intimate bond necessary to effectively transfer the compressive pre-stress to the core 105. Furthermore, the inclusion of the chopped strand glass fibers significantly increases the effective modulus of elasticity and stiffness of the core 105 itself. This enhanced stiffness enables the core 105 to handle the compressive stress from the pre-tensioned reinforcements 110-135 with substantially less strain, which is also critical for maintaining the coupling between the components.

The outer surface of the structure 100 is formed by a co-extruded capstock layer 140, which is devoid of glass fibers. This layer 140 protects the core 105 from UV and infrared (IR) radiation, prevents spalling of glass fibers, and provides an aesthetically pleasing outer surface. To mitigate heating from solar radiation, which could cause the lumber 100 to approach its glass transition temperature (Tg), the capstock 140 may incorporate IR inhibitors such as titanium dioxide, zinc dioxide, or other infrared-reflecting pigments. It may also include UV inhibitors and a high concentration of impact modifiers to reduce surface brittleness and shield the inner core from degradation. Various textures and patterns, such as wood grain, may be formed in the capstock 140 using heated rollers during manufacturing.

Despite its strength, the resulting lumber 100 can exhibit a high density, approximately 2.5 times that of pine, which can present challenges in handling and installation, such as rapid tool wear and difficulty inserting fasteners. To address this, foaming agents may be incorporated into the core 105 material. Suitable agents include chemical foaming agents (CFAs), such as exothermic azodicarbonamide-based compounds or endothermic sodium bicarbonate/citric acid blends, as well as physical foaming agents like nitrogen or carbon dioxide. During extrusion, the foaming agent activates, creating microscopic gas bubbles that become entrapped within the solidified thermoplastic matrix, forming a cellular structure. This process significantly reduces the overall density and weight of the extruded product 100, enhancing its workability for cutting, drilling, and fastening, often eliminating the need for pre-drilled pilot holes. While foaming can reduce the inherent strength of the thermoplastic matrix, the substantial reinforcement provided by the synergistic combination of chopped strand glass fibers and pre-tensioned continuous fibers 110-135 more than compensates for this, ensuring the final lumber 100 retains superior structural performance.

The resulting extruded thermoplastic lumber 100 exhibits exceptional and consistent mechanical properties, in stark contrast to conventional wood lumber, which suffers from inherent variability due to natural defects like knots, cracks, and irregular grain. The controlled manufacturing process ensures a homogeneous structural material with predictable performance. The lumber 100 exhibits a modulus of elasticity in excess of 650,000 psi, and depending on the formulation, may reach or exceed 1.2 to 1.9×10\hat{ }6 psi, equaling or surpassing that of many grades of pine. Furthermore, the lumber demonstrates superior performance under flexural stress. Tests on foamed formulations with a 10% weight reduction have shown a flexural strength at least two to four times that of conventional pine lumber, with observed values of at least 30,000 psi and up to 60,000 psi. Such a formulation includes sufficient foaming agent to reduce the density of the extruded product by 10%. The reduction is determined by comparing the density of the extruded product with the foaming agent to that of the extruded product without a foaming agent. This indicates that the extruded lumber 100, even with the reduced density, fails only under a load that is at least two to four times greater than the failure load for similarly sized pine. In embodiments with a foaming agent, reductions in density of at least 10% are preferred.

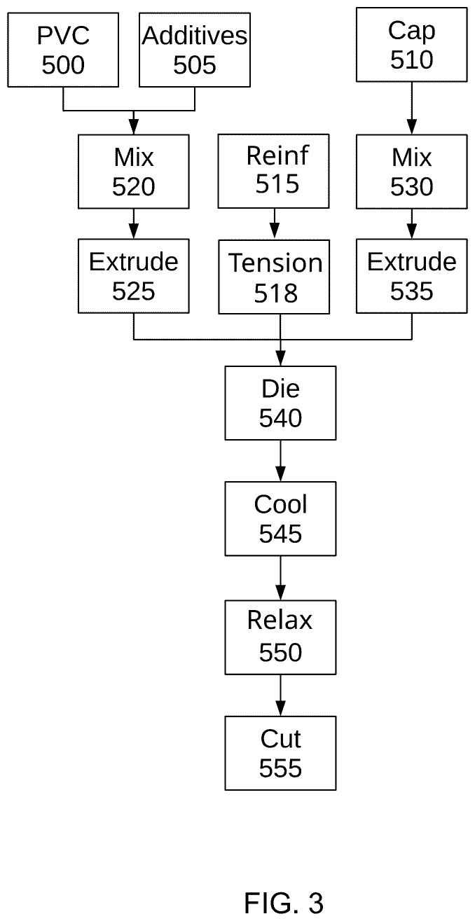

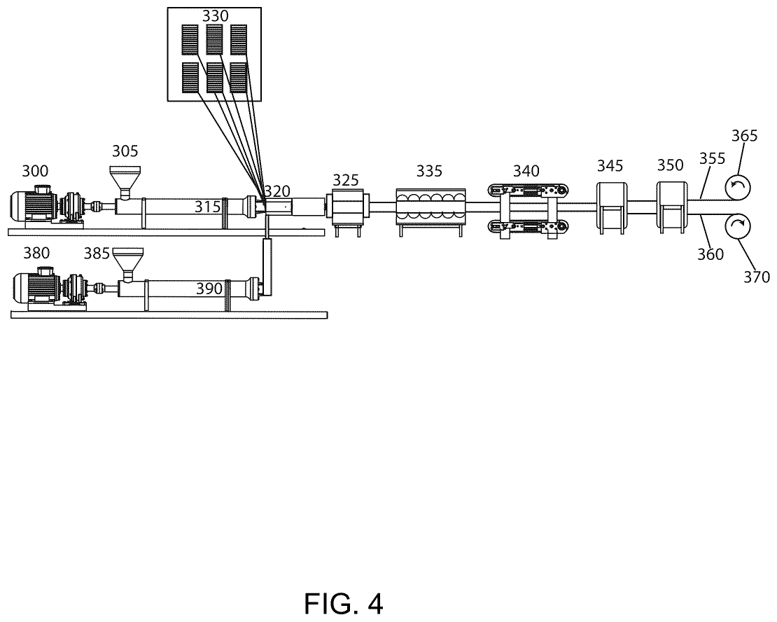

Referring to the flowchart in FIG. 3 and the schematic in FIG. 4, the manufacturing method begins with preparing the material blends. The thermoplastic 200 (e.g., PVC) and additives 505, including the chopped strand glass fibers, are blended in step 520 to create a homogeneous core mixture. Concurrently, components for the capstock 510 are blended in step 530. The core mixture is then introduced into a primary extruder 315 via a hopper 305 (step 525), and the capstock blend is introduced into a co-extruder 330 via a hopper 385 (step 535). Motors 300 and 380 power the extruders, which heat, melt, and convey the materials through a co-extrusion die 320, shaping them into the desired cross-section (step 540).

Simultaneously, a plurality of continuous fiber reinforcements 110-135 are introduced into the process. These reinforcements, which may be pre-impregnated with a thermoplastic resin, are fed from spools in a pultrusion machine (step 515) and guided through tensioning mechanisms 518. A controlled tensile stress, substantially less than the ultimate tensile strength of the reinforcements and the buckling load of the extruded structure, is applied and maintained. The core mixture and capstock layer 140 are co-extruded around these tensioned reinforcements, ensuring they are pultruded axially within and coextensive with the core 105.

To maximize fiber length retention and achieve the critical 60% threshold, a secondary feed port may be employed to introduce the pelletized glass fibers into the extruder 315 downstream from the primary melting zone. This port is designed for minimal shear to reduce mechanical stress on the fibers. Additionally, shear-reducing additives such as lubricants (e.g., stearates, waxes), processing aids (e.g., acrylics), and a fraction of low molecular weight PVC can be included in the formulation to lower the internal friction and drag forces within the polymer melt. The retention level can be verified post-extrusion using methods such as acid digestion, ashing, or image analysis of microtomed sections.

After exiting the die 320, the hot extrudate is sized and cooled (step 545). It passes through a sizing sleeve 325, often within a vacuum sizing tank, which holds the lumber 100 to its proper dimensions while its outer surface is cooled. Further cooling occurs as the lumber moves through cooling sprays or immersion baths 330 and 335, bringing its temperature below its Tg (e.g., to below −176-185° F. (80-85° C.)). A puller 340 maintains a constant pulling rate through these post-extrusion operations. The continuous lumber is then cut by a cutter 345 into specified lengths (step 555). During or after this cutting, the continuous fiber reinforcements 110-135 are severed (step 550), which removes the applied tension and transfers compressive stress to the core 105, completing the creation of the pre-stressed structure. Optional features may include printing stations 350 for applying notations and the inclusion of retroreflective elements in the capstock 140 to allow the lumber to serve as nautical beacons.

The resulting integrally formed extruded thermoplastic lumber 100 can be handled, drilled, and cut using conventional tools. Unlike chemically treated wood, it does not leach toxic chemicals and is inherently resistant to microorganisms and insects. Its structural properties are sufficient for, and often superior to, conventional wood in applications such as dock construction.

Any dimensions or measurable properties provided herein are intended as approximate for an exemplary embodiment and should not be construed as strictly limiting. Such values may be varied by at least ±5% without being considered outside the scope of the invention. While an exemplary embodiment has been described, numerous modifications may be made by those skilled in the art without departing from the true spirit and scope of the invention. The foregoing is to be considered as illustrative only, and all suitable modifications and equivalents are intended to fall within the scope of the invention as claimed.

While an exemplary embodiment of the invention has been described in detail, it should be readily apparent to those skilled in the relevant art that numerous modifications and variations may be made thereto without departing from the true spirit and scope of the invention. With respect to the preceding description, it is to be understood that the optimum relationships for the components and steps of the invention, including potential variations in order, form, content, function, and manner of operation, are deemed readily apparent and obvious to one skilled in the art, and all equivalent relationships to those illustrated in the drawings and described in the specification are intended to be encompassed by the present invention. The preceding description and accompanying drawings are intended to be illustrative of potential modifications that can be made without straying from the fundamental principles of the present invention, the scope of which is to be limited only by the claims that follow. Therefore, the foregoing is to be considered as illustrative only of the principles of the invention. Further, since numerous modifications and changes will readily occur to those skilled in the art, it is not desired to limit the invention to the exact construction and operation as shown and described herein, and accordingly, all suitable modifications and equivalents are intended to fall within the scope of the invention as claimed in the appended claims.

1. A method of manufacturing an integrally formed pre-stressed fiber-reinforced member, comprising:
a. blending a thermoplastic polymer and chopped strand fibers to form a core mixture, wherein the chopped strand fibers are selected to retain at least 60% of their initial average length after extrusion;
b. introducing a plurality of continuous fiber reinforcements into an extruder;
c. applying tensile stress to said continuous fiber reinforcements;
d. co-extruding the core mixture and a capstock layer around the plurality of continuous fiber reinforcements to form a member, wherein said continuous fiber reinforcements are pultruded axially within and coextensive with said core during extrusion;
e. cooling the member to solidify the thermoplastic polymer; and
f. severing the continuous fiber reinforcements to transfer compressive stress to the core.

2. The method of claim 1, wherein the thermoplastic polymer comprises polyvinyl chloride (PVC).

3. The method of claim 1, wherein the chopped strand fibers comprise one of glass fibers and carbon fibers.

4. The method of claim 1, wherein the initial average length of the chopped strand fibers is between 0.125 and 0.50 inches.

5. The method of claim 1, further comprising incorporating at least one foaming agent into the core mixture.

6. The method of claim 5, the incorporated foaming agent being effective to reduce the density of the integrally formed pre-stressed fiber-reinforced member by at least 10%.

7. The method of claim 1, wherein the step of applying tensile stress to said continuous fiber reinforcements comprises maintaining a tension that is less than the ultimate tensile strength of the rovings and the buckling load for the extruded structure.

8. The method of claim 1, further comprising texturing the co-extruded capstock layer to mimic a wood grain.

9. An extruded structural member product, comprising:
a composite core comprising a blend of a thermoplastic polymer and chopped strand fibers, wherein said chopped strand fibers comprise between 15% and 40% by weight of the core material;
a plurality of pultruded continuous fiber reinforcements embedded axially within and coextensive with said core, said reinforcements being pre-tensioned during extrusion; and
an outer capstock layer co-extruded with the core;
wherein the overall extruded structural member product exhibits a modulus of elasticity in excess of 650,000 psi.

10. The extruded structural member product of claim 9, wherein the thermoplastic polymer comprises polyvinyl chloride (PVC).

11. The extruded structural member product of claim 9, wherein the chopped strand fibers are E-glass fibers.

12. The extruded structural member product of claim 9, wherein the chopped strand fibers have an initial average length between 0.125 and 0.50 inches.

13. The extruded structural member product of claim 9, wherein the core has a foaming agent-induced cellular structure.

14. The extruded structural member product of claim 13, wherein the cellular structure exhibits a density of at least 10% less than a density of the core without the cellular structure.

15. The extruded structural member product of claim 9, wherein the plurality of pultruded continuous fiber reinforcements are rovings.

16. The extruded structural member product of claim 9, wherein the capstock layer is devoid of fibers.

17. An integrally formed extruded composite member, comprising:
an extruded core comprising a thermoplastic material blended with chopped strand fibers, wherein the chopped strand fibers are present in the core as a combination of intact pellets, clumps of strands, and individual separated strands;
a plurality of elongated continuous fiber reinforcements pultruded into and coextensive with said core, said reinforcements being pre-tensioned during extrusion such that tensile stress is transferred as compressive stress to the core upon relaxation;
wherein the combination of intact pellets, clumps of strands, and individual separated strands of fibers in the core provides enhanced frictional coupling between the core and the elongated continuous fiber reinforcements, thereby maintaining the transfer of compressive stress; and
a co-extruded capstock layer forming an exterior surface of the member.

18. The integrally formed extruded composite member of claim 17, wherein the thermoplastic material comprises polyvinyl chloride (PVC).

19. The integrally formed extruded composite member of claim 17, wherein the elongated continuous fiber reinforcements are rovings.

20. The integrally formed extruded composite member of claim 17, wherein the core has a foaming agent-induced cellular structure.
